(19) United States
(12) Patent Application Publication
(10) Pub. No.: US 2021/0042860 A1
(43) Pub. Date: Feb. 11, 2021

(54) VEHICLE RENTAL SYSTEM AND VEHICLE RENTAL METHOD

(71) Applicant: HONDA MOTOR CO., LTD., Tokyo (JP)

(72) Inventors: Yuichi Kawasaki, Saitama (JP); Yoshimitsu Ishida, Tokyo (JP)

(21) Appl. No.: 16/985,667

(22) Filed: Aug. 5, 2020

(30) Foreign Application Priority Data
Aug. 9, 2019 (JP) 2019-147304

(51) Int. Cl. G06Q 50/14; H04L 29/08; G06Q 30/06; G06Q 10/02; G06Q 50/30; G06Q 10/06; B60W 60/00; G01C 21/34

(52) U.S. Cl. CPC G06Q 50/14; H04L 67/12; G06Q 30/0645; G01C 21/343; G06Q 50/30; G06Q 10/06315; B60W 60/00253; G06Q 10/02

(57) ABSTRACT

A vehicle rental system includes: plural vehicles; plural vehicle control units included in the respective vehicles, configured to communicate with each other, and configured to execute travel control of the respective vehicles such that a leading vehicle selected from the vehicles is followed by a following vehicle included in the vehicles; and a management server configured to communicate with the respective vehicle control units. The management server is configured to acquire reservation application information, which includes at least a use start place and a use start time of a vehicle to be rented, from a user terminal, create a vehicle dispatch plan including a platoon travel group including one of the vehicles to be moved to the use start place by the use start time and another of the vehicles and a travel plan for the platoon travel group, and transmit the vehicle dispatch plan to the vehicle control units.

### TECHNICAL FIELD

The present invention relates to a vehicle rental system and a vehicle rental method.

### BACKGROUND ART

Car rental systems and car-sharing systems are known as vehicle rental systems for renting vehicles to users. In such vehicle rental systems, the vehicles may be moved according to the desire of the users and the demand for the vehicles. For example, in a known vehicle rental system, staff members transport the vehicles to the use start places desired by the users, and collect the vehicles from the destinations (places to leave the vehicles) desired by the users (for example, JP2017-215769A). Also, in another known vehicle rental system, the vehicles are moved between urban areas and suburbs in order to cope with changes in demand on weekdays and weekends (for example, JP2017-519270A). In the above-mentioned vehicle rental system disclosed in JP2017-215769A, the staff members drive the vehicles to be rented so as to move the vehicles from the stations where the vehicles are stored to the use start places of the users or from the destinations of the users to the stations.

In a case where the staff members move the vehicles, the number of the staff members necessary for moving the vehicles increases as the number of the vehicles to be moved increases. Accordingly, there is a demand for a vehicle rental system that can efficiently move the vehicles with a small number of staff members.

### SUMMARY OF THE INVENTION

In view of such a problem of the prior art, a primary object of the present invention is to provide a vehicle rental system and a vehicle rental method that can reduce the staff members for moving the vehicles.

To achieve such an object, one embodiment of the present invention provides a vehicle rental system (1) including: plural vehicles (2); plural vehicle control units (3) included in the respective vehicles, configured to communicate with each other, and configured to execute travel control of the respective vehicles such that a leading vehicle selected from the vehicles is followed by a following vehicle included in the vehicles; and a management server (4) configured to communicate with the respective vehicle control units, wherein the management server is configured to acquire reservation application information, which includes at least a use start place and a use start time of a vehicle to be rented, from a user terminal (8), create a vehicle dispatch plan including a platoon travel group including one of the vehicles to be moved to the use start place by the use start time and another of the vehicles and a travel plan for the platoon travel group, and transmit the vehicle dispatch plan to the vehicle control units.

According to this arrangement, the management server creates the vehicle dispatch plan for moving the one of the vehicles to the use start place of the user based on the reservation application information. The platoon travel group, which includes the one of the vehicles to be moved to the use start place and another of the vehicles, is created for the vehicle dispatch plan. The vehicles forming the platoon travel group can be set to the following vehicle that follows the leading vehicle, so that the staff members for moving the vehicles can be reduced.

Preferably, the platoon travel group includes the vehicles whose use start places are identical to each other. Alternatively, the platoon travel group includes the vehicles whose use start places are different from each other.

According to this arrangement, the platoon travel group can be created even in a case where the use start places of the vehicles are different from each other, so that the number of the vehicles that can be included in one platoon travel group can be increased. Accordingly, the number of the vehicles moved by each staff member can be increased.

Preferably, the vehicles are configured to dispersedly arranged in plural stations (A, B), and the use start place is selected from one of the stations.

According to this arrangement, the number of the vehicles whose use start places are identical to each other can be increased, so that the number of the vehicles that can be included in one platoon travel group can be increased. Accordingly, the number of the vehicles moved by each staff member can be increased.

Another embodiment of the present invention provides a vehicle rental system (1) including: plural vehicles (2); plural vehicle control units (3) included in the respective vehicles, configured to communicate with each other, and configured to execute travel control of the respective vehicles such that a leading vehicle selected from the vehicles is followed by a following vehicle included in the vehicles; and a management server (4) configured to communicate with the respective vehicle control units, wherein the management server is configured to acquire reservation application information, which includes at least a use end place and a use end time of a vehicle to be rented, from a user terminal (8), create a vehicle dispatch plan including a platoon travel group including one of the vehicles to be moved from the use end place and another of the vehicles and a travel plan for the platoon travel group, and transmit the vehicle dispatch plan to the vehicle control units.

According to this arrangement, the management server creates the vehicle dispatch plan for moving the one of the vehicles from the use end place of the user based on the reservation application information. The platoon travel group, which includes the one of the vehicles to be moved from the use end place and another of the vehicles, is created for the vehicle dispatch plan. The vehicles forming the platoon travel group can be set to the following vehicle that follows the leading vehicle, so that the staff members for moving the vehicles can be reduced.

Preferably, the platoon travel group includes the vehicles whose use end places are identical to each other. Alternatively, the platoon travel group includes the vehicles whose use end places are different from each other.

According to this arrangement, the platoon travel group can be created even in a case where the use end places of the vehicles are different from each other, so that the number of the vehicles that can be included in one platoon travel group can be increased. Accordingly, the number of the vehicles moved by each staff member can be increased.

Preferably, the vehicles are configured to dispersedly arranged in plural stations (A, B), and the use end place is selected from one of the stations.

According to this arrangement, the number of the vehicles whose use end places are identical to each other can be increased, so that the number of the vehicles that can be included in one platoon travel group can be increased. Accordingly, the number of the vehicles moved by each staff member can be increased.

Still another embodiment of the present invention provides a vehicle rental system (1) including: plural vehicles (2) configured to dispersedly arranged in plural stations (A, B); plural vehicle control units (3) included in the respective vehicles, configured to communicate with each other, and configured to execute travel control of the respective vehicles such that a leading vehicle selected from the vehicles is followed by a following vehicle included in the vehicles; and a management server (4) configured to communicate with the respective vehicle control units, wherein the management server is configured to create a vehicle dispatch plan including a platoon travel group including one of the vehicles to be moved from one of the stations to another of the stations and another of the vehicles and a travel plan for the platoon travel group, and transmit the vehicle dispatch plan to the vehicle control units.

According to this arrangement, the management server creates the vehicle dispatch plan for moving the one of the vehicles from the one of the stations to another of the stations. The platoon travel group, which includes the one of the vehicles to be moved from the one of the stations to another of the stations and another of the vehicles, is created for the vehicle dispatch plan. The vehicles forming the platoon travel group can be set to the following vehicle that follows the leading vehicle, so that the staff members for moving the vehicles can be reduced.

Preferably, the management server is configured to create the vehicle dispatch plan so as to move the one of the vehicles from the one of the stations with low prospective demand to another of the stations with high prospective demand based on demand prospect information about the respective stations.

According to this arrangement, the management server creates the vehicle dispatch plan so as to move the one of the vehicles from the one of the stations with low prospective demand to another of the stations with high prospective demand based on the demand prospect information. Thereby, the rental rate of each vehicle can be improved.

Preferably, the management server is configured to create the demand prospect information based on past operation records of the respective stations.

According to this arrangement, the vehicles corresponding to the reservations can be arranged in the stations.

Preferably, the vehicle dispatch plan includes information about the leading vehicle and the following vehicle in the platoon travel group, and the vehicle control unit of the following vehicle is configured to identify the leading vehicle based on the information about the leading vehicle included in the vehicle dispatch plan, communicate with the vehicle control unit of the leading vehicle, and execute the travel control such that the following vehicle follows the leading vehicle.

According to this arrangement, the vehicle control unit of each vehicle included in the platoon travel group sets the own vehicle to the leading vehicle or the following vehicle based on the vehicle dispatch plan. Accordingly, the staff member does not have to set each vehicle to the leading vehicle or the following vehicle.

Preferably, in the vehicle dispatch plan, an autonomous vehicle is selected as the leading vehicle of the platoon travel group.

According to this arrangement, the staff member for driving the leading vehicle can be reduced.

Preferably, in the vehicle dispatch plan, an order of the vehicles from a front in the platoon travel group is determined according to an ascending order of driving performance.

According to this arrangement, the following vehicle follows the leading vehicle which has lower driving performance than the following vehicle, so that the following vehicle can travel such that the behavior of the following vehicle corresponds to that of the leading vehicle to a high degree.

Still another embodiment of the present invention provides a vehicle rental method used by a management server (4) configured to communicate with respective vehicle control units (3) included in respective vehicles (2), configured to communicate with each other, and configured to execute travel control of the respective vehicles such that a leading vehicle selected from the vehicles is followed by a following vehicle included in the vehicles. The vehicle rental method includes the steps of: acquiring reservation application information, which includes at least a use start place and a use start time of a vehicle to be rented, from a user terminal (8), creating a vehicle dispatch plan including a platoon travel group including one of the vehicles to be moved to the use start place by the use start time and another of the vehicles and a travel plan for the platoon travel group based on at least the reservation application information, and transmitting the vehicle dispatch plan to the vehicle control units.

Still another embodiment of the present invention provides a vehicle rental method used by a management server (4) configured to communicate with respective vehicle control units (3) included in respective vehicles (2), configured to communicate with each other, and configured to execute travel control of the respective vehicles such that a leading vehicle selected from the vehicles is followed by a following vehicle included in the vehicles. The vehicle rental method includes the steps of: acquiring reservation application information, which includes at least a use end place and a use end time of a vehicle to be rented, from a user terminal (8), creating a vehicle dispatch plan including a platoon travel group including one of the vehicles to be moved from the use end place and another of the vehicles and a travel plan for the platoon travel group based on at least the reservation application information, and transmitting the vehicle dispatch plan to the vehicle control units.

Still another embodiment of the present invention provides a vehicle rental method used by a management server (4) configured to communicate with respective vehicle control units (3) included in respective vehicles (2) dispersedly arranged in plural stations (A, B), configured to communicate with each other, and configured to execute travel control of the respective vehicles such that a leading vehicle selected from the vehicles is followed by a following vehicle included in the vehicles. The vehicle rental method includes the steps of: creating a vehicle dispatch plan including a platoon travel group including one of the vehicles to be moved from one of the stations to another of the stations and another of the vehicles and a travel plan for the platoon travel group, and transmitting the vehicle dispatch plan to the vehicle control units.

Thus, according to the above aspect, it is possible to provide a vehicle rental system and a vehicle rental method that can reduce the staff members for moving the vehicles.

### BRIEF DESCRIPTION OF THE DRAWINGS

FIG. 1 is a block diagram of a vehicle rental system according to an embodiment;

FIG. 2 is a flow chart of a reservation determination process executed by a reservation determination part;

FIG. 3A is an explanatory diagram showing an outline of a first vehicle dispatch plan including moving a first moving vehicle to the use start place by the use start time;

FIG. 3B is an explanatory diagram showing the first moving vehicle of FIG. 3A being moved to the use start place;

FIG. 3C is an explanatory diagram showing a user associated with the first moving vehicle at the use start place;

FIG. 4A is an explanatory diagram showing an outline of a second vehicle dispatch plan including moving a second moving vehicle.

FIG. 4B is an explanatory diagram showing the second moving vehicle being moved from station B to station A;

FIG. 4C is an explanatory diagram showing the second moving vehicle at station A;

FIG. 5A is an explanatory diagram showing an outline of a third vehicle dispatch plan including moving third moving vehicles.

FIG. 5B is an explanatory diagram showing the third moving vehicles being moved from station A to station B;

FIG. 5C is an explanatory diagram showing the third moving vehicles at station B;

FIG. 6A is an explanatory diagram showing the vehicles in a single-row formation;

FIG. 6B is an explanatory diagram showing the change process for moving the vehicles from the single-row formation of FIG. 6A to a multi-row formation;

FIG. 6C is an explanatory diagram further showing the change process for moving the vehicles of FIG. 6A to a multi-row formation; and

FIG. 6D is an explanatory diagram showing the vehicles in the multi-row formation;

### DESCRIPTION OF THE PREFERRED EMBODIMENT(S)

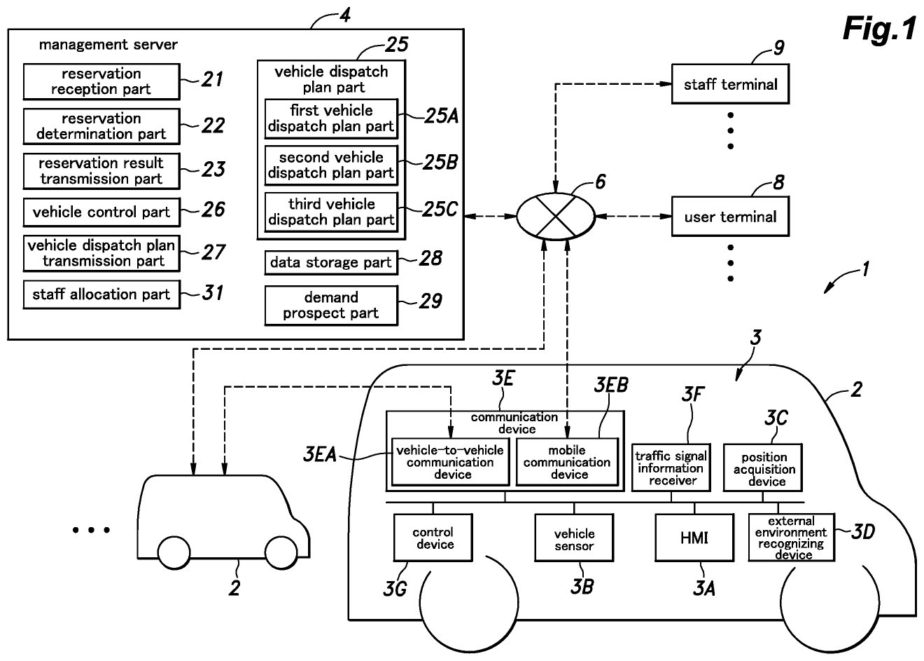

In the following, a vehicle rental system 1 and a vehicle rental method used by the vehicle rental system 1 according to an embodiment of the present invention will be described with reference to the drawings. As shown in FIG. 1, the vehicle rental system 1 includes plural vehicles 2, plural vehicle control units 3 included in the respective vehicles 2, and a management server 4. The management server 4 is configured to communicate with the vehicle control units 3 via the Internet 6, with user terminals 8 owned by respective users via the Internet 6, and with staff terminals 9 owned by respective staff members via the Internet 6.

The vehicles 2 are configured to dispersedly arranged in plural stations (for example, parking lots), and rented to the users according to the reservations by the users. The vehicles 2 range in plural vehicle types to cope with various purposes of use. For example, the vehicles 2 include a sedan, a minivan, a station wagon, an SUV, a sports car, a compact car, a light car (Kei car), a luxury car, a truck, and the like. Further, the vehicles 2 may include a tower wagon, a bus, a construction machine such as a shovel, and the like.

The vehicle control units 3 included in the respective vehicles 2 are configured to communicate with each other and execute travel control of the respective vehicles 2 such that a leading vehicle selected from the vehicles 2 is followed by at least one following vehicle included in the vehicles 2. Each vehicle control unit 3 includes a Human Machine Interface (HMI) 3A, a vehicle sensor 3B, a position acquisition device 3C, an external environment recognizing device 3D, a communication device 3E, a traffic signal information receiver 3F, and a control device 3G. The HMI 3A, the vehicle sensor 3B, the position acquisition device 3C, the external environment recognizing device 3D, the traffic signal information receiver 3F, and the communication device 3E are connected to the control device 3G via a communication means such as a Controller Area Network (CAN).

The HMI 3A is provided in a vehicle cabin of each vehicle 2. The HMI 3A is configured to notify an occupant of various information by a display and/or a voice, and receive an input operation by the occupant. The HMI 3A is, for example, a touch panel display.

The position acquisition device 3C is configured to acquire the current position (the absolute coordinate value represented by latitude and longitude) of the own vehicle 2. For example, the position acquisition device 3C is configured to acquire the current position of the own vehicle 2 based on a GPS signal. The external environment recognizing device 3D is configured to recognize an object around the own vehicle 2 such as another vehicle 2, and includes a camera, a radar, a lidar, a sonar, and the like, for example. Further, the camera included in the external environment recognizing device 3D is configured to recognize an identification code attached to an outer surface of another vehicle 2.

The vehicle sensor 3B is configured to detect a travel state of the own vehicle 2. The vehicle sensor 3B includes, for example, a vehicle speed sensor configured to detect a vehicle speed of the own vehicle 2, an acceleration sensor configured to detect an acceleration of the own vehicle 2, an angular velocity sensor configured to detect a triaxial angular velocity of the own vehicle 2, an accelerator pedal sensor, a brake pedal sensor, and a steering angle sensor.

The communication device 3E includes a vehicle-to-vehicle communication device 3EA and a mobile communication device 3EB. The vehicle-to-vehicle communication device 3EA is configured to connect the control devices 3G of different vehicles 2 (for example, the control device 3G of the own vehicle 2 and that of another vehicle 2) by wireless communication. The mobile communication device 3EB is configured to wirelessly communicate with a base station of a mobile communication system so as to connect the control device 3G of the own vehicle 2 to the management server 4 via the Internet 6. The mobile communication device 3EB may be based on, for example, a fourth or fifth generation mobile communication system.

The traffic signal information receiver 3F is configured to receive a signal transmitted from a traffic signal information transmitter provided on a road and thus acquire traffic signal information. The traffic signal information receiver 3F may be, for example, a receiver of an optical beacon.

The control device 3G is an electronic control unit (ECU) that consists of a computer including a CPU, a ROM, a RAM, and the like. The CPU executes arithmetic processing according to a program, and the control device 3G executes travel control of the own vehicle 2 by controlling a steering device, a driving device such as an engine or an electric motor, and a brake device such as a disc brake, which are provided in the own vehicle 2. More specifically, the control device 3G is configured to adjust a steering angle of the own vehicle 2 by controlling the steering device and adjust the acceleration, the deceleration, and the vehicle speed of the own vehicle 2 by controlling the driving device and the brake device. The control devices 3G of the vehicles 2 forming a platoon travel group (for example, the own vehicle 2 and another vehicle 2) communicate with each other, and thus execute electronic connection control for enabling the vehicles 2 to travel in a platoon and platoon travel control to actually cause the vehicles to travel in a platoon. The platoon travel control includes leading control that is executed when the own vehicle 2 is set to the leading vehicle and following control to cause the own vehicle 2 to follow another vehicle 2 set to the leading vehicle when the own vehicle 2 is set to the following vehicle. The control device 3G is configured to set the own vehicle 2 to the leading vehicle or the following vehicle based on a vehicle dispatch plan received from the management server 4.

The control device 3G of the following vehicle executes the following control, so that the following vehicle can follow the leading vehicle. A state where the following vehicle follows the leading vehicle is called “state where the vehicles 2 travel in a platoon”. Also, a group of vehicles 2 that travels in a platoon is called “platoon travel group”. The platoon travel group includes one leading vehicle and at least one following vehicle. The maximum number of vehicles 2 included in the platoon travel group may be limited to 3 to 6, for example.

The management server 4 is a computer including a CPU, a memory, a storage device, and a communication device. Each of the user terminals 8 and the staff terminals 9 is a computer including a CPU, a memory, a storage device, a communication device, and an HMI, and consists of a smartphone, a tablet PC, a mobile phone, or a PDA, for example. The HMI of each user terminal 8 is an input/output device, and consists of a touch panel display, for example. Each user terminal 8 includes an application for communicating with the management server 4 so as to use the vehicle rental system 1. Each user terminal 8 is configured to create reservation application data (reservation application information) according to the operation of the HMI by the user, transmit the reservation application data to the management server 4, and display the reservation result data (reservation result information) received from the management server 4 on the HMI.

The reservation application data is a record including at least a user identification number, a use start place, a use end place (return place), a use start time, and a use end time (return time) of a vehicle 2 to be rented. Further, the reservation application data may include vehicle information about a vehicle 2 to be rented (vehicle 2 that the user desire to rent).

The HMI of each user terminal 8 is configured to display a reservation application screen including cells that correspond to each piece of information included in the reservation application data. As the user performs an input to the cells of the reservation application screen, the reservation application data is created. The cells that correspond to each piece of information may display selectable items by a pull-down menu or the like so as to enable the user to select one of the selectable items. For example, when the user inputs each piece of information (for example, the use start place, the use end place, the use start time, and the use end time of the vehicle 2 to be rented) on the HMI of each user terminal 8, each user terminal 8 sends each piece of information to the management server 4. The management server 4 may search for selectable vehicles 2 based on each piece of information received from each user terminal 8 and then send information about the selectable vehicles 2 to each user terminal 8. Then, each user terminal 8 may display the selectable vehicles 2 on the HMI so as to enable the user to select one of the selectable vehicles 2.

In the present embodiment, the use start place and the use end place included in the reservation application data are selected from plural stations. For example, the same station may be selected for the use start place and the use end place, or different stations may be selected therefor. The use end place may be selected from plural stations that are set in advance per use start place. In other embodiments, the places other than the stations may be input as the use start place and/or the use end place.

The vehicle information may include a vehicle name, for example. The reservation application screen may display plural selectable vehicle names so as to enable the user to select a desired vehicle name.

Each user terminal 8 is configured to create the reservation application data based on the user's input operation on the reservation application screen and then transmit the reservation application data to the management server 4 via the internet 6.

The management server 4 includes a reservation reception part 21, a reservation determination part 22, a reservation result transmission part 23, a vehicle dispatch plan part 25, a vehicle control part 26, a vehicle dispatch plan transmission part 27, and a data storage part 28. The vehicle dispatch plan part 25 includes a first vehicle dispatch plan part 25A, a second vehicle dispatch plan part 25B, and a third vehicle dispatch plan part 25C.

The reservation reception part 21 is configured to create processing data for each received reservation application data and then write the created processing data in a processing data table stored in the data storage part 28 as a record. The processing data includes a processing number, a user identification number, the use start place, the use end place, the use start time and the use end time, and the vehicle information of the vehicle 2 to be rented. Also, reservation result data is added to the processing data by the undermentioned processing executed by the management server 4.

Further, the data storage part 28 is configured to store a vehicle basic information table, a vehicle schedule table, and a platoon travel plan table in addition to the processing data table. The vehicle basic information table includes vehicle basic data set for all vehicles 2 owned by the vehicle rental system 1. The vehicle basic data include at least characteristic information such as a vehicle identification number, a vehicle name, and equipment of each vehicle 2. The characteristic information may further include information about characteristics of each vehicle 2 such as a capacity (the maximum number of the occupants) of each vehicle 2, a size of a space inside each vehicle 2, whether smoking is allowed inside each vehicle 2, and whether each vehicle 2 is equipped with studless tires.

In the vehicle schedule table, vehicle schedule data of each vehicle 2 is stored. The vehicle schedule data of each vehicle 2 include the current position of each vehicle 2 at each time, whether each vehicle 2 is scheduled to be rented at each time, and a proper parking place (proper holding place) of each vehicle 2 at each time. The proper parking place is a place (station) where each vehicle 2 should be parked while not rented. The proper parking place is set at each time, and one of the stations is set to the proper parking place. The proper parking place does not have to match the use start place and the use end place of the vehicle 2 to be rented. Namely, the proper parking place is not changed according to the use start place and the use end place of the vehicle 2 to be rented. The current position of each vehicle 2 is held at one position corresponding to “being rented” while each vehicle 2 is being rented. The proper parking place is not changed even while each vehicle 2 is rented, and one place (one station) is set to the proper parking place.

The reservation determination part 22 is configured to execute a reservation determination process for each of the processing data so as to determine whether the reservation of each vehicle 2 succeeds (namely, whether the reservation of each vehicle 2 is established). The reservation determination part 22 is configured to determine whether the reservation of each vehicle 2 succeeds based on reservation conditions (for example, the use start place, the use end place, the use start time, the use end time, and the vehicle information of the vehicle 2 to be rented) included in the processing data and the vehicle schedule data of each vehicle 2 stored in the vehicle schedule table. For example, the reservation determination part 22 is configured to refer to the vehicle schedule data of a target vehicle 2 (namely, a vehicle 2 to be a target of the determination by the reservation determination part 22) stored in the vehicle schedule table based on the vehicle information in the processing data and thus determine whether each vehicle 2 satisfying the reservation conditions (for example, the use start place, the use end place, the use start time, and the use end time of the vehicle 2 to be rented) included in the processing data is available.

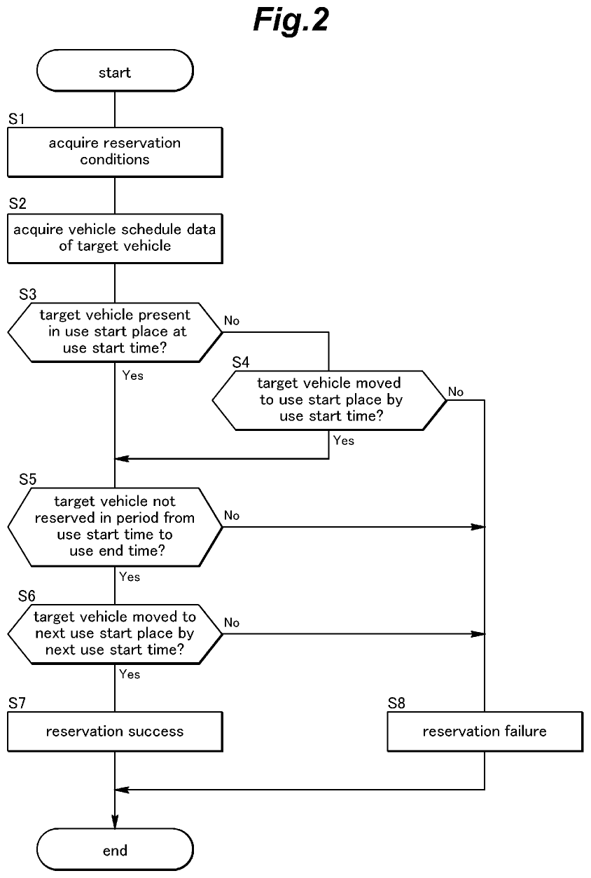

For example, the reservation determination part 22 may determine whether the reservation of each vehicle 2 succeeds based on a reservation determination process shown in FIG. 2. In the reservation determination process, the reservation determination part 22 first acquires the reservation conditions (for example, the use start place, the use end place, the use start time, the use end time, and the vehicle information of the vehicle 2 to be rented) from the processing data (step S1). Subsequently, the reservation determination part 22 acquires the vehicle schedule data of the target vehicle 2 (more specifically, each vehicle 2 satisfying the reservation conditions acquired in step S1) from the vehicle schedule table (step S2).

Next, the reservation determination part 22 determines whether the target vehicle 2 is present in the use start place at the use start time based on the reservation conditions and the vehicle schedule data (step S3).

In a case where the target vehicle 2 is not present in the use start place at the use start time (in a case where the determination result of step S3 is No), the reservation determination part 22 determines whether the target vehicle 2 can be moved to the use start place by the use start time (step S4). For example, in a case where the target vehicle 2 is not reserved a prescribed time before the use start time and a distance between the vehicle position the prescribed time before the use start time and the use start place is equal to or less than a prescribed threshold value, the reservation determination part 22 may determine that the target vehicle 2 can be moved to the use start place by the use start time.

In a case where the target vehicle 2 is present in the use start place at the use start time (in a case where the determination result of step S3 is Yes) or in a case where the target vehicle 2 can be moved to the use start place by the use start time (in a case where the determination result of step S4 is Yes), the reservation determination part 22 determines whether the target vehicle 2 is not reserved in a period from the use start time to the use end time (step S5).

In a case where the target vehicle 2 is not reserved in the period from the use start time to the use end time (in a case where the determination result of step S5 is Yes), the reservation determination part 22 determines whether the target vehicle 2 can be moved to the next use start place (namely, the use start place in the next reservation of the target vehicle 2) by the next use start time (namely, a use start time in the next reservation of the target vehicle 2) (step S6). The reservation determination part 22 executes the determination in step S6 based on the current use end place (namely, the use end place in the current reservation of the target vehicle 2) and the current use end time (namely, the used end time in the current reservation of the target vehicle 2) included in the processing data and the next use start place and the next use start time included in the vehicle schedule data. For example, in a case where a distance between the current use end place and the next use start place is equal to or less than a prescribed threshold value and a difference between the current use end time and the next use start time is equal to or less than a prescribed threshold value, the reservation determination part 22 may determine that the target vehicle 2 can be moved to the next use start place by the next use start time (the determination result of step S6 is Yes). Also, in a case where the next reservation is not made for the target vehicle 2, the reservation determination part 22 may determine that the target vehicle 2 can be moved to the next use start place by the next use start time (the determination result of step S6 is Yes).

In a case where the determination result of step S6 is Yes, the reservation determination part 22 sets “reservation success” as the reservation result (step S7). In addition, in such a case, the reservation determination part 22 adds vehicle reservation information (for example, the use start place, the use start time, the use end place, and the use end time of the target vehicle) to the vehicle schedule data of the target vehicle 2 in the vehicle schedule table.

On the other hand, in a case where the determination result of step S4 is No, in a case where the determination result of step S5 is No, or in a case where the determination result of step S6 is No, the reservation determination part 22 sets “reservation failure” as the reservation result of the processing data (step S8).

The reservation result transmission part 23 is configured to create reservation result information based on the processing data of the target vehicle 2 whose reservation result is determined, and thus transmit the created reservation result information to a target user terminal 8 (for example, a user terminal 8 that has transmitted the reservation application data to the management server 4). The reservation result information includes a reservation result indicating the reservation success or the reservation failure. Further, the reservation result information may include the use start place, the use end place, the use start time, the use end time, and the vehicle information of the target vehicle.

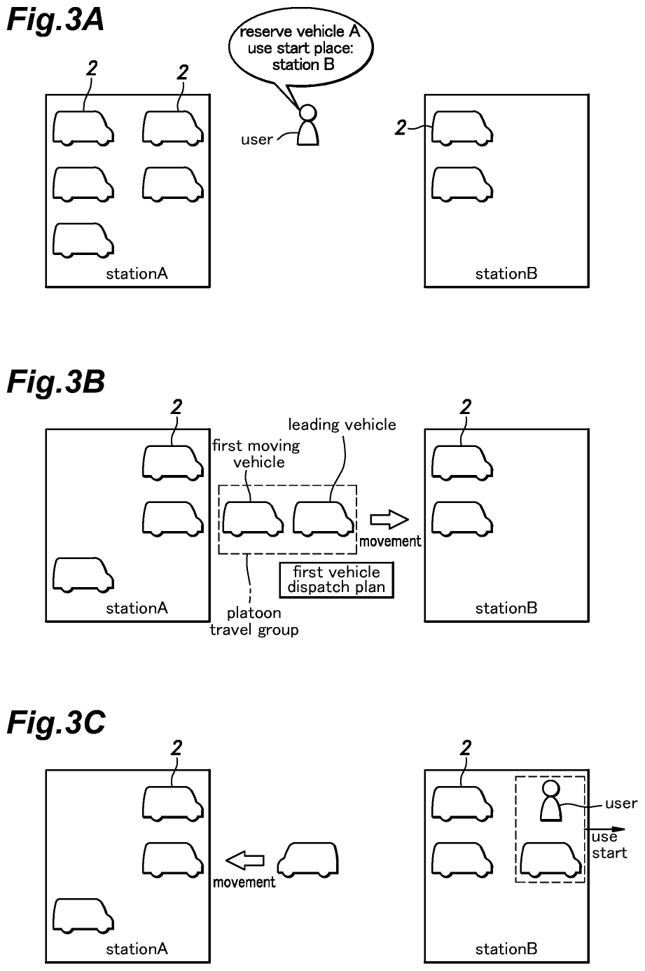

The first vehicle dispatch plan part 25A is configured to select at least one vehicle 2, which is not scheduled to be present in the use start place at the use start time in the future, as a first moving vehicle based on the vehicle schedule data of each vehicle 2 in the vehicle schedule table. Also, the first vehicle dispatch plan part 25A is configured to set a first vehicle dispatch plan for the first moving vehicle. The first moving vehicle is a vehicle 2 that should be moved to the use start place by the use start time. The first moving vehicle can be selected by comparing a position of each vehicle 2 at the use start time with the use start place based on the vehicle schedule data. As shown in FIGS. 3A-3C, the first vehicle dispatch plan is a plan for moving the first moving vehicle to the use start place by the use start time.

The first vehicle dispatch plan part 25A is configured to determine the first vehicle dispatch plan including a movement start place, a movement end place, a movement start time, and a movement route of the first moving vehicle. The movement start place is a position of the first moving vehicle a prescribed time before the use start time of a target reservation (namely, a reservation for which the first moving vehicle is moved), and the movement end place is the use start place of the vehicle 2 in the target reservation. In the present embodiment, any of the stations is set to the movement start place and the movement end place. The movement route is set based on the movement start place and the movement end place. For example, the movement route may be set in advance according to a combination of the movement start place and the movement end place.

The first vehicle dispatch plan is set such that the first moving vehicle arrives at the use start place by a movement end time, which is set a prescribed time before the use start time of the vehicle 2 in the target reservation. The movement start time is set such that the dispatch of the vehicle is completed by the movement end time. The movement start time may be set as a period including a start time point and an end time point. The end time point of the movement start time may be set to a time point obtained by going back from the movement end time by a movement time of the vehicle 2. The movement time may be appropriately set in consideration of the congestion on the road or the like.

Further, the first vehicle dispatch plan part 25A is configured to create a platoon travel group including the first moving vehicle and one or more other vehicles. The first vehicle dispatch plan part 25A is configured to store the information about the vehicles 2 forming the platoon travel group and information about the travel plan for the platoon travel group as a part of the first vehicle dispatch plan. One of the vehicles included in the platoon travel group is the leading vehicle that leads the first moving vehicle by using an electronic connection. The leading vehicle may be a vehicle driven by the staff member or may be an autonomous vehicle that can travel autonomously. Preferably, this autonomous vehicle can travel by unmanned driving. Further, the leading vehicle may be one of the vehicles 2 that can be rented to the users or may be a vehicle 2 that is prohibited from being rented to the users.

The leading vehicle included in the platoon travel group may be selected from the vehicles 2 present in the station where the first moving vehicle is present, or may be selected from the vehicles 2 present in the station different from the station where the first moving vehicle is present.

The platoon travel group may include one or more other vehicles in addition to the above first moving vehicle and the leading vehicle. The other vehicles may include another first moving vehicle to be moved according to another first vehicle dispatch plan different from a target first vehicle dispatch plan. The use start places of the first moving vehicles included in one platoon travel group may be identical to each other, or may be different from each other.

In a case where another first moving vehicle that is different from a target first moving vehicle (namely, a first moving vehicle moved according to the target first vehicle dispatch plan) is present, the first vehicle dispatch plan part 25A forms the platoon travel group such that the target first moving vehicle and another first moving vehicle are included in one platoon travel group on condition that the moving route of the target first moving vehicle and that of another first moving vehicle overlap with each other, another first moving vehicle passes through the movement start place of the target first moving vehicle at the movement start time of the target first moving vehicle, and another first moving vehicle passes through the movement end place of the target first moving vehicle by the movement end time of the target first moving vehicle. Further, the first vehicle dispatch plan part 25A is configured to set one leading vehicle per platoon travel group.

The first vehicle dispatch plan part 25A is configured to update the vehicle schedule data of each target vehicle 2 (namely, each vehicle 2 moved according to the first vehicle dispatch plan) based on the created first vehicle dispatch plan. Accordingly, the vehicle schedule data of each target vehicle 2 is changed such that each target vehicle 2 is located at the use start place at the use start time in the future.

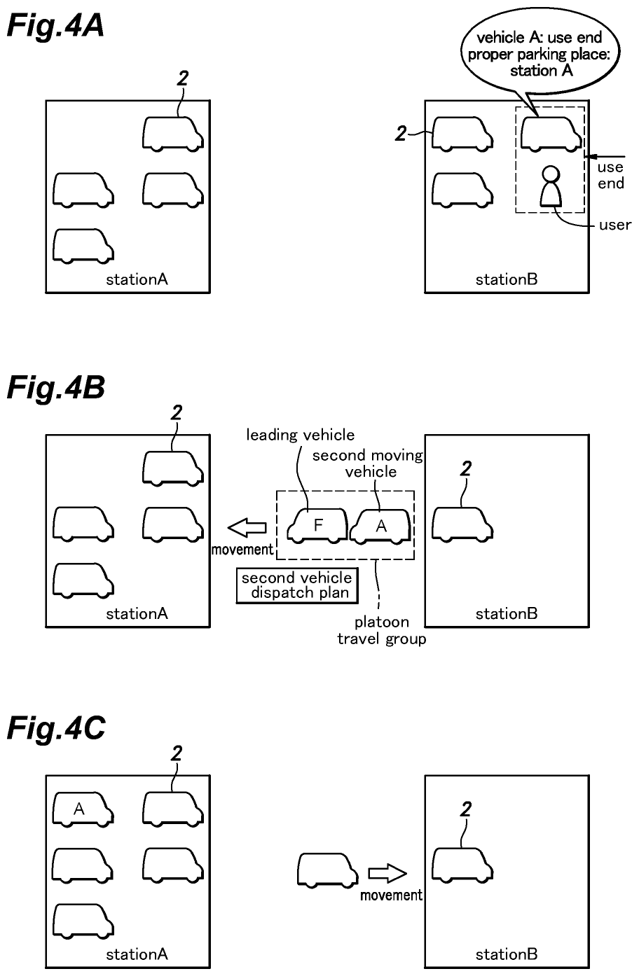

The second vehicle dispatch plan part 25B is configured to select at least one vehicle 2, which is not scheduled to be present in the proper parking place in an arbitrary time in the future and is not reserved on or after the arbitrary time, as a second moving vehicle based on the vehicle schedule data of each vehicle 2 in the vehicle schedule table. Also, the second vehicle dispatch plan part 25B is configured to set a second vehicle dispatch plan for the second moving vehicle. The second moving vehicle is a vehicle 2 that is not reserved on or after the arbitrary time and is parked (held) at a place different from the proper parking place. The arbitrary time may be set at prescribed intervals, for example. The second moving vehicle can be set by comparing the current position of each vehicle 2 at the arbitrary time with the proper parking place based on the vehicle schedule data, selecting each vehicle 2 whose current position is different from the proper parking place, and thus selecting each vehicle 2 that is not reserved on or after the arbitrary time from the selected vehicles 2. As shown in FIGS. 4A-4C, the second vehicle dispatch plan is a plan for moving the second moving vehicle to the proper parking place.

The second vehicle dispatch plan part 25B is configured to determine the second vehicle dispatch plan including a movement start place, a movement end place, a movement start time, and a movement route of the second moving vehicle. The movement start place is the current position of the second moving vehicle at the arbitrary time, and the movement end place is the proper parking place of the second moving vehicle. In the present embodiment, any of the stations is set to the movement start place and the movement end place. The movement route is set based on the movement start place and the movement end place. For example, the movement route may be set in advance according to a combination of the movement start place and the movement end place.

In the second vehicle dispatch plan, the movement start time may be set as a period including a start time point and an end time point. For example, the start time point of the movement start time may be set to an arbitrary time point when the second vehicle dispatch plan part 25B creates the second vehicle dispatch plan. For example, the end time point of the movement start time may be set to a time point a prescribed time after the start time point of the movement start time.

Further, the second vehicle dispatch plan part 25B is configured to create a platoon travel group including the second moving vehicle and one or more other vehicles. The second vehicle dispatch plan part 25B is configured to store the information about the vehicles forming the platoon travel group and information about the travel plan for the platoon travel group as a part of the second vehicle dispatch plan. One of the vehicles included in the platoon travel group is the leading vehicle that leads the second moving vehicle by using an electronic connection. The leading vehicle may be a vehicle driven by the staff member or may be an autonomous vehicle that can travel autonomously. Preferably, this autonomous vehicle can travel by unmanned driving. Further, the leading vehicle may be one of the vehicles 2 that can be rented to the users or may be a vehicle 2 that is prohibited from being rented to the users.

The leading vehicle included in the platoon travel group may be selected from the vehicles 2 present in the station where the second moving vehicle is present, or may be selected from the vehicles 2 present in the station different from the station where the second moving vehicle is present.

The platoon travel group may include one or more other vehicles in addition to the second moving vehicle and the leading vehicle. The other vehicles may include another second moving vehicle to be moved according to another second vehicle dispatch plan different from a target second vehicle dispatch plan. The movement start places (use end places) of the second moving vehicles included in one platoon travel group may be identical to each other, or may be different from each other.

In a case where another second moving vehicle that is different from a target second moving vehicle (namely, a second moving vehicle moved according to the target second vehicle dispatch plan) is present, the second vehicle dispatch plan part 25B forms the platoon travel group such that the target second moving vehicle and another second moving vehicle are included in one platoon travel group on condition that the moving route of the target second moving vehicle and that of another second moving vehicle overlap with each other, another second moving vehicle passes through the movement start place of the target second moving vehicle at the movement start time of the target second moving vehicle, and another second moving vehicle passes through the movement end place of the target second moving vehicle by the movement end time of the target second moving vehicle. Further, the second vehicle dispatch plan part 25B is configured to set one leading vehicle per platoon travel group.

The second vehicle dispatch plan part 25B is configured to update the vehicle schedule data of each target vehicle 2 (namely, each vehicle 2 moved according to the second vehicle dispatch plan) based on the created second vehicle dispatch plan. Accordingly, the vehicle schedule data of each target vehicle 2 is changed such that the current position of each target vehicle 2 at a certain time point in the future is set to the proper parking place.

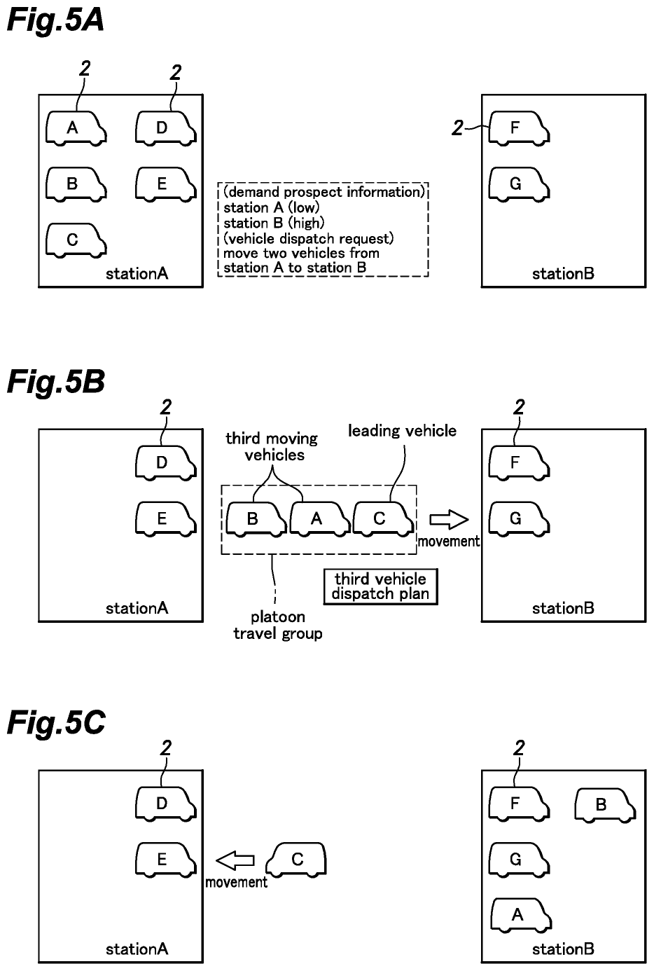

The third vehicle dispatch plan part 25C is configured to create a third vehicle dispatch plan according to a schedule set in advance. As shown in FIGS. 5A-5C, the third vehicle dispatch plan is a plan for moving some of the vehicles 2 present in one station to another station. The third vehicle dispatch plan is created for each target vehicle 2. The third vehicle dispatch plan part 25C may create the third vehicle dispatch plan based on a vehicle dispatch request set in advance. The vehicle dispatch request may include, for example, a movement start time, the name of the station from which the vehicles 2 are moved (hereinafter referred to as “movement start station”), the name of the station to which the vehicles 2 are moved (hereinafter referred to as “movement end station”), and the number of the vehicles 2 to be moved. For example, the vehicle dispatch request may be a request to start moving three vehicles from a station A in an urban area to a station B in a suburb at 1 a.m. on Saturday. Alternatively, for example, the vehicle dispatch request may be a request to start moving three vehicles from the station B in the suburb to the station A in the urban area at 1 a.m. on Monday.

The vehicle dispatch request may be transmitted to the management server 4 according to an input to each staff terminal 9 by the staff member. Alternatively, the vehicle dispatch request may be created based on demand prospect information of each station. The management server 4 includes a demand prospect part 29 configured to create the demand prospect information based on a past operation record of each station and a current reservation record of each station and create the vehicle dispatch request based on the demand prospect information. The demand prospect part 29 may create the demand prospect information per hour in a day, per day in a week, and per month in a year. For example, the demand prospect information may include numerical information such as the prospective rental number of the vehicle 2 per hour in a day, per day in a week, and per month in a year. For example, based on the demand prospect information, it can be determined that the prospective rental number of the vehicles 2 per day from Monday to Friday at the station A in the urban area is greater than the prospective rental number of the vehicles 2 per day on Saturday and Sunday thereat. Namely, based on the demand prospect information, it can be determined that too many vehicles 2 will be arranged in the station A on Saturday and Sunday. For example, based on the demand prospect information, it can be determined that the prospective rental number of the vehicles 2 per day on Saturday and Sunday at the station B in the suburb is greater than the prospective rental number of the vehicles 2 per day from Monday to Friday thereat. That is, based on the demand prospect information, it can be determined that the vehicles 2 arranged in the station B will run short on Saturday and Sunday.

The demand prospect part 29 is configured to select a pair of the stations including a station with low prospective demand (namely, a station that will hold too many vehicles 2) in a certain period in the future and a station with high prospective demand (namely, a station in which the vehicles 2 will run short) in the certain period in the future based on the demand prospect information. Also, the demand prospect part 29 is configured to set the vehicle dispatch request including the names of the movement start station and the movement end station, the number of vehicles 2 to be moved, and the movement start time. Preferably, the movement start station and the movement end station may be set such that the distance between these stations is equal to or less than a prescribed value. In other embodiments, the demand prospect part 29 may be configured to create a group of the stations including one station to which the vehicles 2 are moved and plural stations from which the vehicles 2 are moved. Alternatively, the demand prospect part 29 may be configured to create a group of the stations including plural stations to which the vehicles 2 are moved and one station from which the vehicles 2 are moved.

The third vehicle dispatch plan part 25C is configured to execute an undermentioned third vehicle dispatch plan process based on the vehicle dispatch request and the vehicle schedule data. The third vehicle dispatch plan part 25C first searches the vehicle schedule table based on the name of the movement start station and the movement start time included in the vehicle dispatch request, and then selects the vehicles 2 present at the movement start time at the movement start station as a first selection group.

Then, the third vehicle dispatch plan part 25C selects the vehicle 2, whose reservation on and after the movement start time is not determined, from the first selection group as a second selection group. Then, the third vehicle dispatch plan part 25C selects one or more third moving vehicles from the second selection group such that the number of the third moving vehicles corresponds to the number of the vehicles 2 to be moved included in the vehicle dispatch request. That is, the third moving vehicles are vehicles 2 that are arranged in the movement start station at the movement start time and whose reservation on and after the movement start time is not determined.

The third vehicle dispatch plan part 25C is configured to determine a movement route of the third moving vehicles in the third vehicle dispatch plan. The movement route of the third moving vehicles is set based on the movement start station and the movement end station. For example, the movement route may be set in advance according to a combination of the movement start station and the movement end station.

Further, the third vehicle dispatch plan part 25C is configured to create a platoon travel group including the third moving vehicles and one or more other vehicles. The third vehicle dispatch plan part 25C is configured to store the information about the vehicles 2 forming the platoon travel group and information about the travel plan for the platoon travel group as a part of the third vehicle dispatch plan. One of the vehicles included in the platoon travel group is the leading vehicle that leads the third moving vehicles by using an electronic connection. The leading vehicle may be a vehicle driven by the staff member or may be an autonomous vehicle that can travel autonomously. Preferably, this autonomous vehicle can travel by unmanned driving. Further, the leading vehicle may be one of the vehicles 2 that can be rented to the users or may be a vehicle 2 that is prohibited from being rented to the users.

The leading vehicle included in the platoon travel group may be selected from the vehicles 2 present in the station where the third moving vehicles are present, or may be selected from the vehicles 2 present in the station different from the station where the third moving vehicles are present.

The platoon travel group may include one or more other vehicles in addition to the third moving vehicles and the leading vehicle. The other vehicles may include another third moving vehicle to be moved according to another third vehicle dispatch plan different from a target third vehicle dispatch plan. The use start places of the third moving vehicles included in one platoon travel group may be identical to each other, or may be different from each other. For example, in a case where there are plural vehicles 2 moved from the same movement start station to the same movement end station at the same time, these vehicles 2 may form one platoon travel group.

In a case where another third moving vehicle that is different from target third moving vehicles (namely, third moving vehicles moved according to the target third vehicle dispatch plan) is present, the third vehicle dispatch plan part 25C forms the platoon travel group such that the target third moving vehicles and another third moving vehicle are included in one platoon travel group on condition that the moving route of the target third moving vehicles and that of another third moving vehicle overlap with each other, another third moving vehicle passes through the movement start place of the target third moving vehicles at the movement start time of the target third moving vehicles, and another third moving vehicle passes through the movement end place of the target third moving vehicles by the movement end time of the target third moving vehicles. The number of the vehicles 2 included in the platoon travel group may be 2 to 6, for example. Further, the third vehicle dispatch plan part 25C is configured to set one leading vehicle per platoon travel group.

The third vehicle dispatch plan part 25C is configured to update the vehicle schedule data of the third moving vehicles. At this time, the third vehicle dispatch plan part 25C is configured to change the proper parking place of the third moving vehicles to the movement end station.

Also, the vehicle dispatch plan part 25 may form the platoon travel group by selecting the vehicles 2 from the first to third moving vehicles such that the movement routes of the vehicles 2 overlap with each other and the movement start time and the movement end time of the vehicles 2 correspond to each other. In such a case, the platoon travel group may be set such that the duplication of the leading vehicle is avoided. Namely, the platoon travel group may include only one leading vehicle that is driven by the staff member or travels autonomously.

The created first to third vehicle dispatch plans are stored in the data storage part 28 as the vehicle dispatch plan, and are transmitted to each staff terminal 9 by the vehicle dispatch plan transmission part 27. The staff member acquires the first to third vehicle dispatch plans from each staff terminal 9 and thus recognizes the vehicle 2 which the staff member should move by himself/herself. In other embodiments, the management server 4 may include a staff allocation part 31 configured to allocate staff members to the vehicles 2 to be moved according to the first to third vehicle dispatch plans. The staff allocation part 31 may transmit the first to third vehicle dispatch plans to each staff terminal 9 of the allocated staff member via the vehicle dispatch plan transmission part 27. In a case where the leading vehicle is an autonomous vehicle, the management server 4 may not include the vehicle dispatch plan transmission part 27 and the staff allocation part 31.

The vehicle control part 26 is configured to create a vehicle control instruction for controlling each vehicle 2 included in the platoon travel group based on the first to third vehicle dispatch plans. The vehicle control instruction is created for each vehicle 2 included in the platoon travel group. The vehicle control instruction includes at least the vehicle identification number of the target vehicle 2, the data indicating whether the target vehicle 2 is set to the leading vehicle or the following vehicle, the vehicle identification number of another vehicle 2 included in the same platoon travel group, the travel route of the platoon travel group, a merging place of the platoon travel group, and a merging time of the platoon travel group. The vehicle control part 26 is configured to transmit the vehicle control instruction to the control device 3G of each vehicle control unit 3 included in the corresponding vehicle 2.

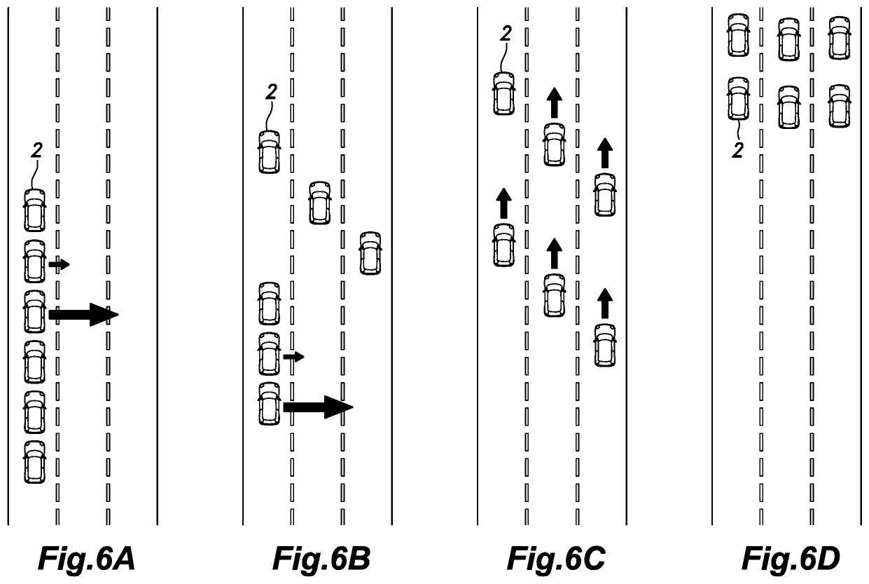

The control device 3G of each vehicle control unit 3 is configured to execute the electronic connection control and the platoon travel control based on the received vehicle control instruction. Incidentally, “electronically connected” denotes a state in which the leading vehicle and the following vehicle can travel in a platoon. The leading vehicle and the following vehicle are electronically connected when the vehicle control units 3 of the leading vehicle and the following vehicle recognize each other and wirelessly communicate with each other in a state where the distance between the leading vehicle and the following vehicle is within a prescribed range. The vehicle control units 3 of the leading vehicle and the following vehicle may identify another vehicle 2 (another vehicle control unit 3) to form the platoon travel group with by the vehicle identification number acquired via wireless communication, or may identify each other based on image information acquired by a camera. For example, a camera mounted on the following vehicle acquires an image code attached to an outer surface of the leading vehicle, and thus the vehicle control unit 3 of the following vehicle recognizes the leading vehicle based on the image code. In a state where the leading vehicle and the following vehicle are electronically connected, the vehicle control units 3 of the leading vehicle and the following vehicle communicate with each other so as to send/receive a vehicle speed, an acceleration, a steering angle, an accelerator position (for example, a position of an accelerator pedal), a brake position (for example, a position of a brake pedal), and a vehicle position of each vehicle 2, as well as formation information of the platoon travel group. The formation information defines a target relative position of the following vehicle with respect to the leading vehicle. The formation information may include information about a selected formation of the platoon travel group and information about a position of the following vehicle in the selected formation. For example, the selected formation is a single-row formation (see FIG. 6A) in which the vehicles 2 forming the platoon travel group are aligned in a row in the fore-and-aft direction (lane direction) or a multi-row formation (see FIG. 6D) in which the vehicles 2 forming the platoon travel group are aligned in multiple rows and widen in the lateral direction orthogonal to the fore-and-aft direction. The formation information is created by the vehicle control unit 3 of the leading vehicle and transmitted to the vehicle control unit 3 of the following vehicle.

In a state where the leading vehicle and the following vehicle are electronically connected, the vehicle control unit 3 (control device 3G) of the following vehicle is configured to execute following control (platoon travel control) for causing the following vehicle to follow the leading vehicle. The vehicle control unit 3 of the following vehicle is configured to calculate a travel path of the leading vehicle, calculate a travel path of the following vehicle such that the following vehicle travels while being kept in a prescribed relative position with respect to the leading vehicle, and control the driving device, the brake device, and the steering device of the own vehicle 2 (namely, the following vehicle) such that the following vehicle follows the calculated travel path.

Next, the operation of the vehicle rental system 1 will be further described. The user who intends to use (rent) the vehicle 2 first activates the application installed in each user terminal 8 so as to cause each user terminal 8 to display the reservation application screen. When the user inputs information to each item of the reservation application screen, the application creates the reservation application data and thus sends the reservation application data to the management server 4. The management server 4 creates the processing data according to the reservation application data transmitted from each user terminal 8, executes the reservation determination process for each of the processing data, and determines whether the reservation of the vehicle 2 succeeds.

The management server 4 creates the first to third vehicle dispatch plans for coping with the user's reservation or arranging vehicles 2 according to the demand for the vehicles 2. The first vehicle dispatch plan is created for moving the vehicles 2 to the use start place by the use start time so as to cope with the user's reservation. The second vehicle dispatch plan is created for moving the vehicles 2, which have been left in the use end place, to the proper parking place so as to cope with the user's reservation. The third vehicle dispatch plan is created for moving the vehicles 2 from one station with low prospective demand in a prescribed period to another station with high prospective demand in the prescribed period so as to cope with the demand for the vehicles 2.

The management server 4 creates the platoon travel group including the first to third moving vehicles to be moved according to the first to third vehicle dispatch plans and one or more other vehicles. The other vehicles in the platoon travel group include at least a vehicle to be the leading vehicle, and may further include other first to third moving vehicles. Accordingly, the first to third moving vehicles are moved to the use start place or the like as the following vehicle to follow the leading vehicle. Thus, the staff member can move the first to third moving vehicles by driving the leading vehicle, and can move to the original place (movement start station) or another place by driving the leading vehicle after the movement of the first to the third moving vehicles is completed. Accordingly, the number of the staff members necessary for moving the first to third moving vehicles can be reduced. Also, in a case where the platoon travel group includes plural vehicles included in any of the first to third moving vehicles, the staff member can move the vehicles 2 more efficiently. The platoon travel group may be a group including one leading vehicle and at least one first moving vehicle, a group including one leading vehicle and at least one second moving vehicle, a group including one leading vehicle and at least one third moving vehicle, or a group including one leading vehicle and at least two of the first to third moving vehicles.

When a prescribed relative positional relationship is established between the vehicles 2 included in one platoon travel group, the leading vehicle and the following vehicle included in the above-mentioned vehicles 2 recognize each other and wirelessly communicate with each other. Namely, the vehicle control units 3 of the vehicles 2 are electronically connected so as to cause the vehicles 2 to travel in a platoon. Incidentally, the relative positional relationship which enables the electronic connection of the leading vehicle and the following vehicle may be, for example, a positional relationship in which the following vehicle travels immediately after the leading vehicle, a positional relationship in which the leading vehicle and the following vehicle are aligned in the lateral direction, a positional relationship in which the distance between the leading vehicle and the following vehicle is within a prescribed value regardless of the directions of the leading vehicle and the following vehicle. When the leading vehicle and the following vehicle become electronically connectable, the vehicle control units 3 of the leading vehicle and the following vehicle may ask each user whether to electronically connect the leading vehicle and the following vehicle by using the HMI 3A of each vehicle 2. Then, the vehicle control units 3 of the leading vehicle and the following vehicle may electronically connect the leading vehicle and the following vehicle according to the input operation to the HMI 3A by each user.

When the leading vehicle and the following vehicle are electronically connected, the vehicle control units 3 of the leading vehicle and the following vehicle execute the platoon travel control (the leading control or the following control). As the leading control, the vehicle control unit 3 of the leading vehicle acquires the travel state information (for example, a vehicle position, a vehicle speed, an acceleration, an angular velocity, an accelerator position, a brake position, a steering angle, and the like) of the own vehicle 2 (namely, the leading vehicle) based on the signals from the position acquisition device 3C and the vehicle sensor 3B and thus transmits the travel state information of the leading vehicle to the vehicle control unit 3 of the following vehicle via the vehicle-to-vehicle communication device 3EA.

As the following control, the vehicle control unit 3 of the following vehicle acquires the travel state information of the leading vehicle via the vehicle-to-vehicle communication device 3EA, acquires the vehicle position, the vehicle speed, and the acceleration of the leading vehicle by the external environment recognizing device 3D, calculates the travel path of the leading vehicle, creates the target path of the own vehicle 2 (namely, the following vehicle) such that the following vehicle travels while being kept in the prescribed relative position with respect to the leading vehicle, and controls the driving device, the brake device, and the steering device such that the own vehicle 2 travels along the target path.

Each following vehicle is electronically connected to the leading vehicle and follows the leading vehicle, and thus the leading vehicle and the following vehicle travel in a platoon. For example, when plural following vehicles follow the leading vehicle in a state where the following vehicles are aligned in a row behind the leading vehicle, the vehicle control unit 3 of each following vehicle may control the own vehicle 2 such that the own vehicle 2 passes through the passing point of the leading vehicle after an inter-vehicle time determined for each following vehicle elapses. While the following vehicle is following the leading vehicle, the vehicle control unit 3 of each following vehicle transmits the position of the own vehicle 2, which is acquired by the position acquisition device 3C, to the vehicle control unit 3 of the leading vehicle.

According to the vehicle rental system 1 as described above, the management server 4 creates the first to third vehicle dispatch plans, and thus the vehicles 2 are moved in the following way. As shown in FIG. 3A, in a case where the user reserves a vehicle A arranged in a station A while inputting a station B as the use start place, the vehicle dispatch plan part 25 of the management server 4 creates the first vehicle dispatch plan. The first vehicle dispatch plan is a plan for moving the reserved vehicle

A (first moving vehicle) from the station A to the station B by the use start time of the user. The first vehicle dispatch plan includes the platoon travel group including the first moving vehicle and the leading vehicle and the travel plan for the platoon travel group. The staff member checks the first vehicle dispatch plan by using each staff terminal 9, drives the vehicle B (leading vehicle), and moves the vehicle A from the station A to the station B according to the first vehicle dispatch plan (see FIG. 3B). At this time, the vehicle A (first moving vehicle) is electronically connected to the vehicle B (leading vehicle) and thus follows the vehicle B.

Then, the staff member releases the electronic connection of the vehicle A and the vehicle B at the station B and parks (arranges) the vehicle A at the station B. Accordingly, the user can rent the vehicle A at the station B at the use start time (see FIG. 3C). Then, the staff member can drive vehicle B so as to return to the station A, for example.

As shown in FIG. 4A, in a case where the user returns the vehicle A to the station B (use end place) when finishing using the vehicle A, the vehicle dispatch plan part 25 of the management server 4 creates the second vehicle dispatch plan, since the current position of the vehicle A (station B) and the proper parking place of the vehicle A (station A) are different from each other. The second vehicle dispatch plan is a plan for moving the vehicle A (second moving vehicle), which is left in a place different from the proper parking place, to the proper parking place. The second vehicle dispatch plan includes the platoon travel group including the second moving vehicle and the leading vehicle and the travel plan for the platoon travel group. The staff member checks the second vehicle dispatch plan by using each staff terminal 9, drives the vehicle F (leading vehicle), and moves the vehicle A from the station B to the station A according to the second vehicle dispatch plan (see FIG. 4B). At this time, the vehicle A (second moving vehicle) is electronically connected to the vehicle F (leading vehicle) and thus follows the vehicle F.

The staff member releases the electronic connection of the vehicle A and the vehicle F at the station A, and parks (arranges) the vehicle A at the station A. Accordingly, the vehicle A is parked (arranged) at the station A as the proper parking place (see FIG. 4C). Then, the staff member can drive the vehicle F so as to return to the station B, for example.

As shown in FIG. 5A, the management server 4 creates the third vehicle dispatch plan in a prescribed schedule based on the vehicle dispatch request. The third vehicle dispatch plan is a plan for moving the vehicles 2 between the stations based on the vehicle dispatch request. For example, the vehicle dispatch request is created based on the demand prospect information of each station. In this example, the vehicle dispatch request is a request for moving two vehicles 2 from the station A to the station B. The third vehicle dispatch plan includes the platoon travel group including the vehicles A, B (third moving vehicles) and the leading vehicle and the travel plan for the platoon travel group. The staff member checks the third vehicle dispatch plan by using each staff terminal 9, drives the vehicle C (leading vehicle), and moves the vehicles A, B from the station A to the station B according to the third vehicle dispatch plan (see FIG. 5B). At this time, the vehicle A (third moving vehicle) is electronically connected to the vehicle C (leading vehicle) and thus follows the vehicle C. Also, the vehicle B (third moving vehicle) is electronically connected to the vehicle A (preceding vehicle) and thus follows the vehicle A. Namely, the vehicles C, A, and B travel in a platoon in which the vehicle C is set to the leading vehicle.

The staff member releases the electronic connection of the vehicles C, A and B at the station B, and parks (arranges) the vehicles A, B at the station B. Accordingly, the vehicles A, B are arranged at the station B (see FIG. 5C). At this time, the proper parking place of the vehicles A, B is changed to the station B. Then, the staff member can drive the vehicle C so as to return to the station A, for example.

The leading vehicle in the platoon travel group may be the autonomous vehicle instead of the vehicle 2 driven by the staff member.

The formations of the platoon travel group formed as the following vehicle follows the leading vehicle include plural formations having different lengths in the fore and aft direction. As described above, the formations include the single-row formation and the multi-row formation. A formation change button for changing the formation is displayed on the HMI 3A of the leading vehicle. When the formation change button is operated by the user, the vehicle control units 3 of the leading vehicle and the following vehicle execute a formation change process. The vehicle control unit 3 of the leading vehicle may display the formation change button on the HMI 3A based on the number of lanes on the road and traffic signal information. The number of lanes on the road is acquired by the external environment recognizing device 3D of the leading vehicle or is acquired based on map information. The traffic signal information is received from the traffic signal information transmitter.

In the present embodiment, the formation change process includes a single-multi change process for changing the single-row formation to the multi-row formation. FIGS. 6A-6D shows how the following vehicles are moved when the formation of the platoon travel group is changed from the single-row formation to the multi-row formation by the single-multi change process. In the single-multi change process, the formation of the platoon travel group is changed in an order of FIG. 6A, FIG. 6B, FIG. 6C, FIG. 6D. In the following, the single-multi change process will be described on the assumption that the single-row formation is changed to the multi-row formation with the number of rows N.

As shown by arrows in FIG. 6A, in the first step of the single-multi change process, the following vehicles positioned from the second to the Nth from the head (namely, the leading vehicle) are moved to the different lanes from the leading vehicle and from each other. Thereafter, as shown by a small arrow in FIG. 6B, the following vehicle positioned at the (N+2)th from the head is moved to the lane of the following vehicle positioned at the second from the head. At the same time, as shown by a big arrow in FIG. 6B, the following vehicle positioned at the (N+3)th from the head is moved to the lane of the following vehicle positioned at the third from the head. By repeating such a movement, as shown in FIG. 6C, all the vehicles 2 forming the platoon travel group are allocated to the respective lanes as evenly as possible. Thereafter, as shown by arrows in FIG. 6C, the vehicle control unit 3 of each following vehicle increases the speed of the own vehicle 2 in order to reduce the inter-vehicle distance between the own vehicle 2 and the preceding vehicle. Accordingly, as shown in FIG. 6D, the single-multi change process is completed.

The formation change process includes a multi-single change process for changing the formation of the platoon travel group from the multi-row formation to the single-row formation. In the present embodiment, the multi-single change process is executed by executing the steps of the single-multi change process in reverse order. Accordingly, it is possible to prevent the order of the vehicles 2 in the single-row formation from being changed by sequentially executing the single-multi change process and the multi-single change process.

For each formation such as the single-row formation and the multi-row formation, the relative position of the following vehicle with respect to the leading vehicle is set in advance. The vehicle control unit 3 of each following vehicle creates the travel path of the own vehicle 2 so as to maintain the relative position of the following vehicle with respect to the leading vehicle, and thus controls the driving device, the brake device, and the steering device such that the own vehicle 2 travels along the travel path.

A situation where the vehicle control unit 3 displays the formation change button will be exemplified in the following. When the leading vehicle arrives at a position immediately before an intersection, the vehicle control unit 3 of the leading vehicle determines whether all the vehicles 2 forming the platoon travel group can pass through the intersection. More specifically, the vehicle control unit 3 of the leading vehicle determines whether the following vehicle at the end of the platoon travel group can pass through the intersection before the traffic signal turns red if the current formation of the platoon travel group is maintained. This determination can be made based on a signal from the traffic signal information receiver 3F, the vehicle position of the following vehicle acquired via the vehicle-to-vehicle communication, and the vehicle speed of the own vehicle 2 (leading vehicle) acquired by the vehicle sensor 3B. In a case where the result of this determination is “No”, the vehicle control unit 3 of the leading vehicle determines whether the following vehicle at the end of the platoon travel group can pass through the intersection before the traffic signal turns red if the current formation of the platoon travel group is changed to another formation. In a case where the vehicle control unit 3 determines that the following vehicle at the end thereof can pass through the intersection before the traffic signal turns red if the current formation is changed to another formation, the vehicle control unit 3 of the leading vehicle may display the formation change button on the HMI 3A of the leading vehicle.

In the single-row formation, an order of the vehicles 2 from the front in the platoon travel group may be determined according to an ascending order of driving performance of each vehicle 2. Accordingly, the following vehicles follow the leading vehicle (or the preceding vehicle) which has lower driving performance than the following vehicle, so that the following vehicle can travel such that the behavior of the following vehicle corresponds to that of the leading vehicle (or the preceding vehicle) to a high degree.

According to the above embodiment, the management server 4 creates the vehicle dispatch plan for moving the vehicle 2 to the use start place of the user based on the reservation application information. Also, the management server 4 creates the vehicle dispatch plan for moving the vehicle 2 from the use end place of the user based on the reservation application information. Also, the management server 4 creates a vehicle dispatch plan for moving the vehicle 2 from one station to another station. In each vehicle dispatch plan, the management server 4 creates the platoon travel group including the vehicle 2 to be moved and another vehicle. The vehicles 2 forming the platoon travel group can be set to the following vehicle that follows the leading vehicle, so that the staff members for moving the vehicles 2 can be reduced. Also, the vehicle 2 for moving the staff member can be secured after the movement of the vehicles 2 is completed.

In the vehicle rental system 1, the user can select one of the stations as the use start place, and can select one of the stations as the use end place. Accordingly, the vehicle rental system 1 can be more convenient. Also, the number of the vehicles 2 whose use start places and/or use end places are identical to each other can be increased, so that the number of the vehicles 2 that can be included in one platoon travel group can be increased. Accordingly, the number of the vehicles 2 moved by each staff member can be increased.

Also, the vehicle rental system 1 creates the vehicle dispatch plan for moving the vehicles 2 between the stations, so that each vehicle 2 can be arranged at an optimum place according to the change in demand for the vehicles 2 depending on the location of each station. Accordingly, the operation rate (rental rate) of each vehicle 2 can be improved.

If the autonomous vehicle is used as the leading vehicle of the platoon travel group in each vehicle dispatch plan, the vehicles 2 can be moved without a person (driver). Also, not all of the vehicles 2 owned by the vehicle rental system 1 consist of the autonomous vehicles, but a part of the vehicles 2 (for example, the vehicles 2 that can be used as the leading vehicles) owned by the vehicle rental system 1 consist of the autonomous vehicles, so that the costs of the vehicles 2 can be reduced.

Concrete embodiments of the present invention have been described in the foregoing, but the present invention should not be limited by the foregoing embodiments and various modifications and alterations are possible within the scope of the present invention. For example, various methods may be applied to the method for matching the first to third moving vehicles in order to create the platoon travel group. For example, the platoon travel group may be created by matching the first to third moving vehicles whose movement start stations and movement end stations are identical to each other.

1. A vehicle rental system, comprising:
plural vehicles;
plural vehicle control units included in the respective vehicles, configured to communicate with each other, and configured to execute travel control of the respective vehicles such that a leading vehicle selected from the vehicles is followed by a following vehicle included in the vehicles; and
a management server configured to communicate with the respective vehicle control units,
wherein the management server is configured to
acquire reservation application information, which includes at least a use start place and a use start time of a vehicle to be rented, from a user terminal,
create a vehicle dispatch plan including a platoon travel group including one of the vehicles to be moved to the use start place by the use start time and another of the vehicles and a travel plan for the platoon travel group, and
transmit the vehicle dispatch plan to the vehicle control units.

2. The vehicle rental system according to claim 1, wherein the platoon travel group includes the vehicles whose use start places are identical to each other.

3. The vehicle rental system according to claim 1, wherein the platoon travel group includes the vehicles whose use start places are different from each other.

4. The vehicle rental system according to claim 1, wherein the vehicles are configured to dispersedly arranged in plural stations, and the use start place is selected from one of the stations.

5. A vehicle rental system, comprising:
plural vehicles;
plural vehicle control units included in the respective vehicles, configured to communicate with each other, and configured to execute travel control of the respective vehicles such that a leading vehicle selected from the vehicles is followed by a following vehicle included in the vehicles; and
a management server configured to communicate with the respective vehicle control units,
wherein the management server is configured to
acquire reservation application information, which includes at least a use end place and a use end time of a vehicle to be rented, from a user terminal,
create a vehicle dispatch plan including a platoon travel group including one of the vehicles to be moved from the use end place and another of the vehicles and a travel plan for the platoon travel group, and
transmit the vehicle dispatch plan to the vehicle control units.

6. The vehicle rental system according to claim 5, wherein the platoon travel group includes the vehicles whose use end places are identical to each other.

7. The vehicle rental system according to claim 5, wherein the platoon travel group includes the vehicles whose use end places are different from each other.

8. The vehicle rental system according to claim 5, wherein the vehicles are configured to dispersedly arranged in plural stations, and the use end place is selected from one of the stations.

9. A vehicle rental system, comprising:
plural vehicles configured to dispersedly arranged in plural stations;
plural vehicle control units included in the respective vehicles, configured to communicate with each other, and configured to execute travel control of the respective vehicles such that a leading vehicle selected from the vehicles is followed by a following vehicle included in the vehicles; and
a management server configured to communicate with the respective vehicle control units,
wherein the management server is configured to
create a vehicle dispatch plan including a platoon travel group including one of the vehicles to be moved from one of the stations to another of the stations and another of the vehicles and a travel plan for the platoon travel group, and
transmit the vehicle dispatch plan to the vehicle control units.

10. The vehicle rental system according to claim 9, wherein the management server is configured to create the vehicle dispatch plan so as to move the one of the vehicles from the one of the stations with low prospective demand to another of the stations with high prospective demand based on demand prospect information about the respective stations.

11. The vehicle rental system according to claim 10, wherein the management server is configured to create the demand prospect information based on past operation records of the respective stations.

12. The vehicle rental system according to claim 1, wherein the vehicle dispatch plan includes information about the leading vehicle and the following vehicle in the platoon travel group, and
the vehicle control unit of the following vehicle is configured to identify the leading vehicle based on the information about the leading vehicle included in the vehicle dispatch plan, communicate with the vehicle control unit of the leading vehicle, and execute the travel control such that the following vehicle follows the leading vehicle.

13. The vehicle rental system according to claim 1, wherein in the vehicle dispatch plan, an autonomous vehicle is selected as the leading vehicle of the platoon travel group.

14. The vehicle rental system according to claim 1, wherein in the vehicle dispatch plan, an order of the vehicles from a front in the platoon travel group is determined according to an ascending order of driving performance.

15. A vehicle rental method used by a management server configured to communicate with respective vehicle control units included in respective vehicles, configured to communicate with each other, and configured to execute travel control of the respective vehicles such that a leading vehicle selected from the vehicles is followed by a following vehicle included in the vehicles, the vehicle rental method comprising the steps of:
acquiring reservation application information, which includes at least a use start place and a use start time of a vehicle to be rented, from a user terminal,
creating a vehicle dispatch plan including a platoon travel group including one of the vehicles to be moved to the use start place by the use start time and another of the vehicles and a travel plan for the platoon travel group based on at least the reservation application information, and
transmitting the vehicle dispatch plan to the vehicle control units.

16. A vehicle rental method used by a management server configured to communicate with respective vehicle control units included in respective vehicles, configured to communicate with each other, and configured to execute travel control of the respective vehicles such that a leading vehicle selected from the vehicles is followed by a following vehicle included in the vehicles, the vehicle rental method comprising the steps of:
acquiring reservation application information, which includes at least a use end place and a use end time of a vehicle to be rented, from a user terminal,
creating a vehicle dispatch plan including a platoon travel group including one of the vehicles to be moved from the use end place and another of the vehicles and a travel plan for the platoon travel group based on at least the reservation application information, and
transmitting the vehicle dispatch plan to the vehicle control units.

17. A vehicle rental method used by a management server configured to communicate with respective vehicle control units included in respective vehicles dispersedly arranged in plural stations, configured to communicate with each other, and configured to execute travel control of the respective vehicles such that a leading vehicle selected from the vehicles is followed by a following vehicle included in the vehicles, the vehicle rental method comprising the steps of:
creating a vehicle dispatch plan including a platoon travel group including one of the vehicles to be moved from one of the stations to another of the stations and another of the vehicles and a travel plan for the platoon travel group, and
transmitting the vehicle dispatch plan to the vehicle control units.
